(19) United States
(12) Patent Application Publication
(10) Pub. No.: US 2026/0236676 A1
(43) Pub. Date: Aug. 13, 2026

(54) SYSTEMS AND METHODS FOR ANALYSIS AND COMPARISON OF ELECTRONIC DOCUMENTS

(71) Applicant: Q2 Software, Inc., Austin, TX (US)

(72) Inventors: Ali Zonoozi, Toronto (CA); Cameron Christopher Farr Plouffe, Etobicoke (CA); Daniel Wagner, Thornhill (CA); Frederico Tommasi Caroli, Burnaby (CA); Kollol Das, Toronto (CA)

(21) Appl. No.: 19/532,140

(22) Filed: Feb. 6, 2026

Related U.S. Application Data
(60) Provisional application No. 63/756,667, filed on Feb. 10, 2025.

(51) Int. Cl. G06F 40/279; G06N 3/042

(52) U.S. Cl. CPC G06F 40/279; G06N 3/042

(57) ABSTRACT

Systems and methods for document comparison are disclosed. Embodiments may determine matching entities within documents utilizing a model such as a large language model or the like to produce graphs of documents being compared according to a graph schema defining entities and relationships. The graphs generated for the documents can be compared to determine matching entities in the documents despite the fact that these entities may be referred to differently in each of those documents.

### RELATED APPLICATIONS

This application claims the benefit of priority under 35 U.S.C. §119 to United States Provisional Application No. 63/756,667 filed February 10, 2025, entitled “SYSTEMS AND METHODS FOR ANALYSIS AND COMPARISON OF COMPLEX DOCUMENTS,” which is hereby fully incorporated by reference herein for all purposes.

### TECHNICAL FIELD

This disclosure relates generally to electronic document processing. In particular, embodiments of this disclosure relate to the analysis and comparison of electronic documents. Even more specifically, embodiments of this disclosure relate to analysis and comparison of electronic documents using natural language processing, machine learning, graph algorithms, large language models or structured data extraction.

### BACKGROUND

Modern enterprises generate, store, and rely upon vast quantities of electronic documents in the ordinary course of business. Such documents may include, by way of non-limiting example, contracts, loan agreements, insurance policies, regulatory filings, technical specifications, reports, correspondence, and transactional records. These documents are frequently large, complex, and authored or revised over extended periods of time by different individuals, departments, or external parties. As a result, enterprise document repositories often contain multiple documents—or multiple sections within a single document—that describe overlapping subject matter and refer to the same underlying real-world entities, such as persons, business organizations, assets, locations, accounts, or events.

A recurring problem in this environment is that the same entity is often referenced in different ways across documents or within different portions of a document. For example, a business entity may be identified by its full legal name in one section, by an abbreviated name or trade name in another section, and by an internal identifier or account number elsewhere. A person may be referred to by a full name, a last name only, a title, or a role (e.g., “borrower” or “guarantor”). Monetary values, assets, or locations may be expressed using different formats, units, or descriptive phrases. Over time, and particularly as documents are amended or supplemented, discrepancies can arise that are difficult to detect through manual review.

A challenging task in modern enterprises is thus ensuring consistency of documentation, especially when documents are large and complex. As this documentation is prepared, over time discrepancies can arise within different sections of a document or across documents which are structurally very different. These challenges are exacerbated by the fact that enterprise documents are not uniform. Documents to be compared may differ widely in format, content, semantics, organization, and underlying structure. The manner in which content is organized, annotated, and presented can also differ significantly. Even when documents describe the same underlying facts or entities, they may do so using different terminology, phrasing, or contextual framing.

Accurately determining when different portions of text refer to the same underlying entity is critical in a wide range of enterprise scenarios. Historically, a variety of approaches have been employed in an attempt to determine whether different documents, or sections thereof, refer to the same entity. Despite significant effort, prior approaches have proven inadequate for reliably identifying matching entities across large, complex, or heterogeneous electronic documents.

What is needed, therefore, are improved systems and methods for comparing electronic documents.

### SUMMARY

As discussed, a variety of approaches have been employed in an attempt to determine whether different documents, or sections thereof, refer to the same entity. Some systems rely on manual review by subject matter experts, which is time-consuming, expensive, and prone to human error, particularly as document volumes scale. Other approaches employ simple text matching, keyword searches, or rule-based heuristics that compare exact strings or predefined patterns. Such techniques are brittle and fail when entities are referenced using different names, abbreviations, formats, or contextual descriptions.

More advanced approaches have attempted to extract data fields from documents and normalize those fields for comparison. However, these approaches typically depend on rigid templates, predefined schemas, or domain-specific rules that do not generalize well across document types or evolving document structures. Accordingly, existing solutions generally lack the ability to effectively extract entity-related information from diverse documents and represent that information in a structured, context-aware manner that supports accurate comparison.

To solve these problems, among others, embodiments as disclosed herein may extract graphs for the purpose of document matching (e.g., matching entities within or across documents) utilizing LLMs. In particular, embodiments may approach the problem of comparing large and complex documents (e.g., that are structurally different), or sections within the same document, by extracting (e.g., normalized) graphs from each document and comparing the extracted graphs (e.g., to determine matching entities).

Specifically, embodiments as described herein may facilitate document comparison to determine matching (e.g., equivalent) entities (e.g., data points) within documents (or portions of documents. In particular, embodiments may use an LLM to produce graphs of documents (or portions of the same document) being compared according to a graph schema defining entities and relationships. The graphs generated for the documents can be compared to determine equivalent entities in the documents despite the fact that these entities may be referred to differently in each of those documents.

In embodiments the graph schema may be subdivided into a number of subgraph schemas. Each of the subgraph schemas may include a portion of the graph schema (e.g., include the entities and relationships of a portion of the graph schema), where the portions of the of the graph schema included in different subgraph schemas may overlap (e.g., two subgraph schemas may include one or more same entities or relationships).

Documents that are received to be compared (which may be two different documents or independent documents generated from a same original document) may be processed to be placed in a textual format if needed. Moreover, in certain embodiments, each document may be divided into document portions, each document portion comprising a page sequence of one or more (e.g., sequential) pages of the document. Thus, a graph may be generated for each document by generating subgraphs for each document portion using the LLM according to the subgraph schema and then merging the generated subgraphs.

In one embodiment, the subgraph schema may be provided to the LLM by converting or mapping the subgraph schema into an equivalent JSON (subgraph) schema representation. Thus, what is returned from the LLM may be the entities or relationships extracted by the LLM represented in this JSON (subgraph) schema. This JSON representation of the subgraph can then be converted or mapped into a (sub)graph representation according to the graph schema.

The subgraphs produced for a document can then be merged to generate a (e.g., unified or single) graph representing the document utilizing one or more entity identification or merging strategies (e.g., algorithms) to identify entities that should be merged. Once unified graphs are generated for each of the documents being compared, the unified graphs for each document may be compared (matched) to identify entities (nodes) in each of the unified graphs that match (e.g., are to be identified as the same entity). These matching entities or discrepancies (e.g., and their citations in one or both of the documents) may then be identified to a user such as by presenting them in a textual or graphical format through an interface.

Accordingly, embodiments may provide a number of advantages. As will be recalled, existing approaches for comparing documents and identifying equivalent entities within or across documents suffer from significant technical and practical limitations, For example, certain approaches operate primarily at a syntactic level and therefore fail to capture semantic equivalence. As a result, they are unable to reliably identify matching entities when those entities are expressed using different terminology, formatting, contextual roles, or narrative structure. Conversely, these methods often generate false positives when similar language is used to describe unrelated concepts, thereby reducing their practical utility. Other approaches are generally effective only for simple, well-structured documents and for extracting isolated, atomic data points. They struggle when relevant information is distributed across multiple sections, expressed redundantly, or dependent on contextual relationships. Moreover, these systems typically lack a unified representation capable of capturing relationships among extracted data points, which makes it difficult to reconcile or compare related information either within a document or across documents.

Embodiments as disclosed herein address these deficiencies by reframing document comparison as a graph-based entity matching problem rather than a purely text-based analysis. Instead of comparing raw text or isolated extracted fields, embodiments as disclosed herein extract normalized, schema-based graph representations from each document. In these representations, entities of interest are modeled as nodes and relationships between entities are modeled as edges, thereby capturing both the data points and the semantic relationships among them. This approach enables equivalent entities to be identified even when they are described differently across documents or across different sections of the same document.

To further address the challenges posed by large and complex documents, embodiments as disclosed herein divide documents into portions, such as page ranges, and decompose comprehensive graph schemas into overlapping subgraph schemas. Extraction is then performed independently for each document portion and each subgraph schema, which allows the system to scale effectively while maintaining coverage of desired data points. The resulting subgraphs are subsequently merged using tailored algorithms producing a unified graph representation for each document.

Embodiments as disclosed herein also mitigate known limitations of large language models by constraining their use to schema-guided extraction rather than unconstrained generation. Graph schemas are converted into structured representations, such as JSON schemas, which guide the extraction process and enable validation of LLM outputs. By enforcing schema compliance and filtering invalid or incomplete outputs, embodiments as disclosed herein significantly improve the consistency and reliability of extracted graph data.

Once unified document graphs are constructed, embodiments as disclosed herein apply graph-based matching techniques to identify equivalent entities and discrepancies both within a single document and across multiple documents. These techniques account for entity properties, normalized values, semantic similarity, and the surrounding graph structure, including relationships to other entities. By leveraging the interdependencies among data points, the system is able to distinguish true discrepancies from differences in expression.

The advantages of embodiments arise from aspects of embodiments as disclosed herein either alone or working in combination. Schema driven graph representations provide a consistent semantic framework across documents, while (e.g., overlapping) subgraph schemas create shared reference points that facilitate reliable merging. Constrained, schema-aware use of LLMs improves extraction accuracy without sacrificing scalability. Graph merging and normalization algorithms reconcile redundant or fragmented information, and configurable entity matching strategies enable precise comparison even in the presence of variation, redundancy, or partial data.

Through these combined aspects, embodiments as disclosed herein provide a scalable, automated, and robust mechanism for comparing large and complex documents. This approach significantly reduces effort, improves accuracy, increases speed of document comparison and enables reliable identification of machine entities that would otherwise have heretofore been difficult or impractical.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions and/or rearrangements may be made within the scope of the disclosure without departing from the spirit thereof, and the disclosure encompasses all such substitutions, modifications, additions and/or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1 is a block diagram of one embodiment of a computer vision based security system.

FIGS. 2A-2C (collectively FIG. 2) depict an example of an interface for the presentation of similarities or differences across documents.

FIGS. 3A-3B (collectively FIG. 3) is a flow diagram of an embodiment of document comparison.

FIG. 4 depicts an example of a portion of a graph schema and associated subgraph schemas.

FIG. 5 is a flow diagram of one embodiment of method for document splitting.

FIG. 6 depicts an example mapping of subgraph schema to a corresponding JSON schema.

FIG. 7 depicts an example of a mapping configuration.

FIG. 8 depicts an example of a conversion of returned entities in JSON into a subgraph.

FIG. 9 depicts an example observation.

FIG. 10 depicts one embodiment of matching or comparison using a merging configuration.

FIG. 11 depicts an example merging configuration.

FIG. 12 depicts an example of graph merging according to an embodiment.

FIG. 13 is a flow diagram for one embodiment of a matching method.

FIG. 14 depicts an example of a configuration according to an embodiment.

FIG. 15 depicts an example of entity matching in graphs according to an embodiment.

FIG. 16 depicts an example of source citations according to an embodiment.

### DETAILED DESCRIPTION

The disclosure and various features and advantageous details thereof are explained more fully with reference to the exemplary, and therefore non-limiting, embodiments illustrated in the accompanying drawings and detailed in the following description. It should be understood, however, that the detailed description and specific examples, while indicating the preferred embodiments, are given by way of illustration only and not by way of limitation. Descriptions of known programming techniques, computer software, hardware, operating platforms and protocols may be omitted so as not to unnecessarily obscure the disclosure in detail. Various substitutions, modifications, additions and/or rearrangements within the spirit and/or scope of the underlying inventive concept will become apparent to those skilled in the art from this disclosure.

Modern enterprises generate, store, and rely upon vast quantities of electronic documents in the ordinary course of business. Such documents may include, by way of non-limiting example, contracts, loan agreements, insurance policies, regulatory filings, technical specifications, reports, correspondence, and transactional records. These documents are frequently large, complex, and authored or revised over extended periods of time by different individuals, departments, or external parties. As a result, enterprise document repositories often contain multiple documents—or multiple sections within a single document—that describe overlapping subject matter and refer to the same underlying real-world entities, such as persons, business organizations, assets, locations, accounts, or events.

A recurring problem in this environment is that the same entity is often referenced in different ways across documents or within different portions of a document. For example, a business entity may be identified by its full legal name in one section, by an abbreviated name or trade name in another section, and by an internal identifier or account number elsewhere. A person may be referred to by a full name, a last name only, a title, or a role (e.g., “borrower” or “guarantor”). Monetary values, assets, or locations may be expressed using different formats, units, or descriptive phrases. Over time, and particularly as documents are amended or supplemented, discrepancies can arise that are difficult to detect through manual review.

These challenges are exacerbated by the fact that enterprise documents are not uniform. Documents to be compared may differ widely in format, content, semantics, organization, and underlying structure. By way of example, documents may be authored or stored as plain text, HTML, PDF, word processing files, XML, LaTeX, spreadsheets, or proprietary formats, each of which represents information using different structural conventions, metadata, and hierarchies. Even where documents are nominally in the same format, their internal organization may differ substantially, such as through the use of headings, subsections, tables, footnotes, exhibits, or embedded objects.

In addition to structural variation, the manner in which content is organized, annotated, and presented can differ significantly. One document may express key information in narrative paragraphs, while another conveys similar information in tabular form or as enumerated lists. Certain documents may rely heavily on defined terms or cross-references, whereas others may use descriptive language without explicit definitions. These differences in presentation complicate efforts to compare documents or align corresponding portions of content.

Further, even when documents describe the same underlying facts or entities, they may do so using different terminology, phrasing, or contextual framing. For instance, one document may refer to a “loan amount,” while another refers to the same value as a “principal balance.” Dates, addresses, and identifiers may be formatted differently, abbreviated, or partially omitted. In some cases, documents may be authored in different languages or adapted for different jurisdictions or regulatory regimes. Moreover, the meaning of a particular word, phrase, or data value may depend heavily on its surrounding context, such that identical or similar text strings may refer to different entities in different portions of a document, or different text strings may refer to the same entity when considered in context.

Accurately determining when different portions of text refer to the same underlying entity is critical in a wide range of enterprise scenarios. By way of example, financial institutions must ensure consistency across loan agreements, collateral descriptions, insurance documents, and disclosures to avoid errors that could delay closings or trigger regulatory penalties. Legal teams must verify that defined parties, obligations, and assets are described consistently across related agreements. Compliance and audit processes often require reconciliation of references to customers, accounts, transactions, or locations across multiple documents. More generally, document review, due diligence, risk assessment, and data governance processes all depend on the ability to reliably identify matching entities across heterogeneous documentation.

Historically, a variety of approaches have been employed in an attempt to determine whether different documents, or sections thereof, refer to the same entity. Some systems rely on manual review by subject matter experts, which is time-consuming, expensive, and prone to human error, particularly as document volumes scale. Other approaches employ simple text matching, keyword searches, or rule-based heuristics that compare exact strings or predefined patterns. Such techniques are brittle and fail when entities are referenced using different names, abbreviations, formats, or contextual descriptions.

More advanced approaches have attempted to extract data fields from documents and normalize those fields for comparison. However, these approaches typically depend on rigid templates, predefined schemas, or domain-specific rules that do not generalize well across document types or evolving document structures. They often struggle with unstructured or semi-structured text and lack the ability to account for contextual meaning. As a result, these systems may generate false positives by incorrectly matching unrelated entities, or false negatives by failing to recognize that different references correspond to the same entity.

Accordingly, despite significant effort, prior approaches have proven inadequate for reliably identifying matching entities across large, complex, and heterogeneous electronic documents. In particular, existing solutions generally lack the ability to effectively extract entity-related information from diverse documents and represent that information in a structured, context-aware manner that supports accurate comparison. These limitations leave enterprises exposed to inconsistency, error, and inefficiency, and highlight the need for improved systems and methods for matching electronic documents, or sections within documents, based on underlying entity references rather than superficial textual similarity.

To solve these problems, among others, embodiments as disclosed herein may extract graphs for the purpose of document matching (e.g., matching entities within or across documents) utilizing LLMs. In particular, embodiments may approach the problem of comparing large and complex documents (e.g., that are structurally different), or sections within the same document, by extracting (e.g., normalized) graphs from each document and comparing the extracted graphs (e.g., to determine matching entities).

Before discussing embodiments in more detail, some additional context may be useful. Extracting structured data from documents is a well-established concept. There are a variety of approaches that attempt to extract data based on traditional (e.g., machine learning and non machine learning based) approaches. However, the kind of detailed extraction from complex documents needed for document matching is currently not available. In the main, current solutions appear to be restricted to extracting simple data points for single documents.

While LLMs have come a long way since the debut of ChatGPT, their application to complex documents, and their comparison, is not obvious or straightforward. Usually straightforward schema-based data extraction from a large document fails using LLMs. To elaborate, extracting structured data from documents has long been recognized as a useful precursor to comparing documents and identifying matching entities across or within those documents. By transforming unstructured or semi-structured text into structured representations—such as records, fields, relationships, and normalized values—systems can more readily align corresponding entities, reconcile inconsistencies, and perform systematic comparisons. Traditional approaches to structured extraction have included rule-based systems or template-driven parsers, each of which attempts to impose structure on document content so that downstream processes, including entity matching, can be performed more reliably. More recently, attempts have been made to utilize LLMs for extracting data from documents.

The level of detailed, consistent, and comprehensive extraction required for accurate comparison of large and complex documents is, however, not currently achievable solely using LLMs. In practice, most LLM-based extraction solutions are limited to identifying relatively simple data points—such as names, dates, or isolated values—from individual documents. LLMs are thus typically applied on a per-document basis and are not designed to produce a complete, normalized, and internally consistent representation of all entity references across an entire document, let alone across multiple documents that may differ substantially in structure and terminology.

This situation exists in no small part at least because the application of LLMs to complex documents presents several technical challenges. Straightforward schema-based extraction from long or highly structured documents often fails because LLMs do not inherently enforce completeness, determinism, or coverage guarantees. When documents exceed certain lengths or include deeply nested structures, LLMs may omit relevant data points, extract them inconsistently, or prioritize more salient or recently encountered information over less prominent but equally important content. As a result, extractions may be incomplete or biased toward particular sections of a document, undermining their usefulness for systematic comparison.

Additionally, in many real-world documents, information associated with a single entity is not confined to a single location. Data points may be distributed across multiple sections, exhibits, or cross-references, with partial information appearing in different contexts and with varying levels of specificity. In some cases, the same information is repeated with slight variations or updates over time. Effective entity matching therefore requires combining, reconciling, and normalizing these distributed references into a coherent representation. LLMs, particularly when used in flat or one-pass extraction modes, generally lack the ability to reliably aggregate such fragmented data, resolve internal inconsistencies, or apply consistent normalization rules across an entire document.

Furthermore, LLM outputs are inherently probabilistic and may vary across invocations, even when applied to the same document with the same prompts. This variability complicates downstream comparison and auditing processes, which often require repeatable and explainable results. LLMs also tend to blur distinctions between extraction, inference, and generation, sometimes filling perceived gaps with plausible but incorrect information. In the context of entity matching and document comparison, such behavior can lead to erroneous associations between entities or the introduction of inaccuracies that are difficult to detect.

For these reasons, LLMs are presently ill-suited for use as the primary and solitary mechanism for the detailed, structured extraction and normalization required to accurately identify matching entities across large, complex, and heterogeneous documents.

While LLMs alone may not be suitable for matching of complex documents, in certain embodiments they may be usefully employed in conjunction with other techniques for entity matching within or across documents. Specifically, the use of graph based representations of documents for document matching may be highly effective. More particularly, mapping documents to a graph based representation (e.g., according to a graph schema) is particularly well suited for entity matching within or across documents because it aligns naturally with the way real-world entities, references, and relationships are expressed in complex documents, while overcoming many of the structural and semantic limitations of linear or flat representations.

A graph based representation allows entities to be modeled explicitly as nodes, with references, attributes, and relationships represented as edges. This makes it possible to represent the same underlying entity—such as a person, organization, asset, or location—as a single conceptual node even when that entity is referenced in multiple ways throughout a document or across documents. Different textual mentions (e.g., legal name, abbreviated name, defined term, role-based reference, or identifier) can be linked to the same node, preserving the original language of each reference while establishing an explicit equivalence at the data model level. This decoupling of how an entity is referred to from what entity is being referred to may be quite useful in the context of entity matching.

Moreover, documents themselves are inherently relational. Legal, financial, technical, and other types of documents routinely define entities, assign roles, describe relationships, impose obligations, and establish dependencies. A graph schema can capture these relationships directly, such as “is a party to,” “secures,” “is located at,” “references,” “ has borrower,” “has guarantor”, “is defined in.” When entity matching is performed within such a relational context, the surrounding graph structure provides powerful disambiguation signals. For example, two similar names appearing in different documents may be confidently matched if they participate in analogous relationships with the same entities (e.g., assets, transactions, or counterparties), while similar names can be kept distinct if their related entities (e.g., subgraph or relational neighborhood).

Graph representations also naturally accommodate the fragmentation and distribution of data in complex documents. In many documents, information about the same entity is spread across multiple sections, schedules, exhibits, or cross-references. A graph schema allows partial facts to be incrementally attached to an entity node as they are discovered, without requiring that all attributes be extracted from a single contiguous block of text. Over time, multiple mentions can enrich the same node, and conflicting or variant values can be retained as separate edges or annotations rather than being collapsed.

Graph based representations of documents thus support normalization and comparison across heterogeneous documents. Different documents may emphasize different aspects of the same entity or express relationships using different terminology or structures. By mapping document content into a common graph schema, these variations can be reconciled at the schema level rather than at the text level. For example, one document’s “borrower” and another document’s “obligor” can both be connected to a common entity type and relationship pattern, enabling matching even when surface language diverges. This schema driven alignment is particularly important when comparing documents with different formats, authorship conventions, or purposes.

Part and parcel with these representation advantages, graphs may enable sophisticated matching algorithms to be applied. Entity matching can leverage not only attribute similarity but also structural similarity, graph neighborhood (e.g., related entities or subgraphs) overlap, path-based reasoning, and consistency constraints across graphs being compared (or portions thereof). For instance, two entity nodes may be inferred to match if they share multiple connected neighbor nodes (e.g., the same collateral, transaction date, borrower, business, etc.), even if no single attribute provides a definitive match on its own. This multi-factor, neighborhood aware matching cannot usually be achieved using text-based or table-based approaches.

As can be seen then, mapping documents to a graph schema offers significant advantages for entity matching within or between large, complex, or heterogeneous documents. Representing such documents in a graph according to a graph schema is, however, not straightforward. Such representation is difficult for many of the same reasons that entity matching between or within documents may be difficult as p[previously elaborated on. Namely, complex documents rarely present entities and relationships in a uniform or explicit manner. Entities may be introduced implicitly, referenced indirectly, or described incrementally over time. Determining when a particular phrase constitutes a new entity, a reference to an existing entity, or merely descriptive text requires nuanced interpretation of context, scope, and intent.

Similarly, the relationships that must be captured in a graph are frequently not expressed as simple subject–predicate–object statements. In legal, financial, and technical documents, relationships may be conditional, temporal, hierarchical, or qualified by exceptions and definitions. The use of natural language ambiguity and variability also pose a challenge to accurate graph representation of documents. The same relationship can be described using different linguistic constructions, and similar language can convey different meanings depending on context.

Normalization and entity resolution across a document for graph representation also requires global consistency. A graph is not merely a collection of locally extracted facts; it is an integrated representation in which entity identity must be stable across all references. Achieving this consistency requires comparing and reconciling information extracted from disparate parts of the document, sometimes with incomplete or conflicting data. For example, an entity may be partially identified in one section by name and elsewhere by role or identifier.

Thus, the use of graph representations for document matching may present difficulties for at least some of the exact same reasons that entity matching within or across such documents is difficult. Accordingly, embodiments as used herein may address such problems by utilizing LLMs in the generation of graph representations of documents (e.g., according to a graph schema).

Extracting graph representations of documents through use of an LLMs is, however, not without its own problems. Although LLMs are often capable of identifying entities and relationships in isolation, translating those findings into a coherent, accurate, and internally consistent graph is substantially more complex and remains problematic in practice. Graphs are inherently relational and non-linear structures, whereas LLM outputs are typically generated sequentially as linear text. When instructed to emit nodes, edges, and attributes of a graph, LLMs frequently produce outputs that suffer from connectivity and coherence issues, such as missing links between related entities, duplicated nodes representing the same entity, or edges that reference undefined or inconsistently named nodes. Since global graph constraints may not be enforced, small inconsistencies in this generation can lead to structurally invalid or semantically incorrect graphs.

These problems are exacerbated by the complexity of graph schemas that may be used to represent complex documents. In many enterprise use cases, the graph schema into which document content is to be mapped is rich and expressive, encompassing multiple entity types or relationships. Accurately adhering to such a schema requires the LLM to track numerous rules and structural expectations simultaneously. As schema complexity increases, prompts necessarily grow longer and more detailed, often including extensive instructions, examples, and validation requirements. Such large prompts can approach practical token limits and become highly sensitive to minor changes in wording or ordering, leading to brittle behavior and inconsistent outputs across runs.

In addition, LLMs typically lack a robust notion of incremental construction and validation when generating structured artifacts like graphs. Unlike traditional graph-building systems that can create nodes and edges programmatically while checking constraints at each step, LLMs tend to generate the entire structure in one or more monolithic outputs. If an error occurs early in generation, such as misclassifying an entity type or misnaming a node, subsequent portions of the output may compound that error, resulting in cascading inconsistencies that are difficult to detect or correct automatically.

Another significant challenge of using LLMs for graph representation and document matching relates to traceability and citation. In many document comparison and entity-matching scenarios, it is important not only to identify (e.g., matching) entities, but also to link them back to precise locations in the source documents for verification, auditing, or user review. While LLMs can often reference coarse-grained locations such as page numbers, providing citations at finer granularity (such as specific paragraphs, clauses, table cells, or character offsets) typically requires searching or aligning against extracted text. LLMs usually do not maintain an internal index of document content, which makes fine-grained citations ambiguous or error-prone. As a result, graph elements may be weakly or inaccurately associated with the source documents.

Finally, the use of LLMs for graph extraction often blurs the boundary between extraction and inference by the LLM (or “hallucination”). LLMs may infer or conjure up whole cloth relationships that are plausible but not explicitly supported by the document or may “fill in” missing links to produce a more complete-looking graph. This is undesirable in contexts that require faithful representation of document content.

Thus, while embodiments may utilize LLMs in generating graph representations of documents to be matched to allow for more efficient and more effective matching, embodiments may employ certain techniques to more effectively extract graphs from documents utilizing LLMs. In particular, embodiments may utilize effective techniques for extracting graphs based on a graph schema and LLMs. Embodiments may thus improve current solutions by constructing schema-based graphs using LLMs, where these LLMs may otherwise struggle to perform reliably given the complexity of documents, large number of pages, or the specific data points to be extracted.

In certain embodiments, therefore, a graph schema may be divided into a set of subgraph schemas. Thus, graphs produced for documents may comprise one or more subgraphs corresponding to subgraph schemas defined in the graph schema. The subgraphs determined for each document being compared may be combined into a graph for the document. Accordingly, interdependent extracted entities (e.g., data points) that are often spread across the document with varying degrees of redundancy and atomicity may be combined in a manner that accounts for graph properties. These schema based graphs representing data of each document may then be compared to effectuate comparison of the documents themselves. The same methodology used to combine subgraphs for a document may be used by embodiments to compare the composite graphs extracted from each document. By using graphs for such extractions and comparison, graph relationships may be used to determine better matches between nodes of those graphs. Additionally, embodiments may map LLM citations to individual lines in a document.

Accordingly, embodiments as described herein may facilitate document comparison (also referred to as document matching) to determine equivalent entities (e.g., data points) within documents (or portions of documents. In particular, embodiments may use an LLM to produce graphs of documents (or portions of the same document) being compared according to a graph schema defining entities (that will be represented by nodes in a graph) and relationships (which will be represented as edges in a graph).

This graph schema may be defined for a particular domain for example, based on a set of sample documents or other insights or data. The graphs generated for the documents can be compared to determine equivalent entities (e.g., data points) in the documents despite that these entities may be referred to differently in each of those documents. To increase the accuracy of performing the graph determination of the documents, in certain embodiments the graph schema may be subdivided into a number of subgraph schemas. Each of the subgraph schemas may include a portion of the graph schema (e.g., include the entities and relationships of a portion of the graph schema), where the portions of the of the graph schema included in different subgraph schemas may overlap (e.g., two subgraph schemas may include one or more same entities or relationships). This overlap between entities or relationships in the subgraph schemas can be effectively utilized to improve graph merging (e.g., the overlapping entities or relationships can be used as anchors to merge subgraphs)

Documents that are received to be compared (which may be two different documents or independent documents generated from a same original document) may be pre-processed to be placed in a textual format if needed. For example, each page may be scanned by an OCR system, if needed, and the text rendered or formatted as close as possible to the original layout of the document. In the output of the pre-processing each line of text is prefixed by the page and line number to allow data extracted from a document to be easily cited or identified (e.g., by an LLM). Additionally, mappings between the prefixes and text bounding boxes are maintained to provide citation highlighting graphically if desired.

Moreover, in certain embodiments, each document may be divided into document portions, each document portion comprising a page sequence of one or more (e.g., sequential) pages of the document. This is because in certain cases the documents being compared may be quite large (e.g., 300 or more pages), so they may not fit into the context window of other input interfaces provided by an LLM. Additionally, even if a given document does fit into the LLM input, LLMs sometimes tend to skip information while extracting from very large contexts. Thus, in some embodiments, documents being compared are split into manageable document portions (e.g., page sequences) upon which graph extraction may be independently performed (and where that extraction may be performed in parallel to speed the process) .

In some embodiments, the subgraph schema is used to split the document into document portions. Specifically, in some embodiments a (page sequencing) prompt instructing an LLM to determine page portions (e.g., including page sequences) and including the subgraph schema and the document may be submitted to an LLM. The LLM may also be instructed to take into consideration content spillovers from previous pages in the prompt. The page portions (e.g., page sequences) determined by the LLM can then be used as the document portions.

Thus, a graph may be generated for each document by generating subgraphs for each document portion according to the subgraph schema and then merging the generated subgraphs. Specifically, to generate a graph for a document, each document portion of the document can be evaluated according to each subgraph schema. For each document portion and subgraph schema, zero or more subgraphs for that document portion and that subgraph schema can be generated based on the text of that document portion and the subgraph schema. The subgraphs generated for each document portion for each subgraph schema can then be merged to produce the graph of the document.

To generate the zero or more subgraphs corresponding to a particular document portion and particular subgraph schema, that subgraph schema and document portion may be provided to a LLM in a (graph or subgraph generation) prompt where the (graph or subgraph generation) prompt includes an instruction requesting the LLM to perform graph extraction to generate zero or more subgraphs from the included document portion according to the subgraph schema included in the (graph or subgraph generation) prompt.

As LLMs may struggle with directly extracting graphs from documents (and in particular from sequences of pages from a document), especially when there are many different entities (e.g., in the graph or subgraph), embodiments may employ certain techniques for submitting a subgraph schema in a prompt to increase the accuracy of this (e.g., sub)graph extraction. In one embodiment, for example, before the subgraph schema is provided to the LLM in a prompt, the subgraph schema may be converted or mapped into an equivalent JSON (subgraph) schema representations, as JSON schemas may be better supported by LLMs. A mapping configuration may be used to generate the JSON schema from the corresponding subgraph schema. Using a JSON schema has several benefits, like the ability to restrict types and apply required properties.

Thus, it is the JSON (subgraph) schema (i.e., the JSON representation of the subgraph schema) that is submitted to the LLM in (graph or subgraph generation) prompt to generate one or more subgraphs from an included document portion. Specifically, the JSON schema, instructions, any examples, and text of the page portions (e.g., page sequences) are all fed as a prompt to the LLM. The text of the page portions can be provided in association with citation data such as line number information corresponding to the page and line number of the original document. Specifically, each line may be prefixed with a line number and the LLM may be instructed to cite those sources when providing output for entities.

Accordingly, what is returned from the LLM may be the entities (or other entity data) or relationships (or other relationship data) extracted by the LLM represented in this JSON (subgraph) schema. The entity data for an entity (or relationship data for a relationship) may include citation data (e.g., pages or line numbers) for that entity. This JSON representation of the subgraph can then be converted or mapped into a (sub)graph representation according to the graph schema (e.g., the subgraph schema corresponding to the JSON (subgraph) schema submitted in the prompt). In certain embodiments, the LLM may provide (e.g., an array) of entities or relationships (e.g., entity groups) according to the JSON schema. These entities or relationships (e.g., entity groups) are then converted into subgraphs using the relationship definitions of the mapping configurations. Before performing this mapping or conversion, validations or pruning may be performed on the JSON representation of the extracted entities or relations. JSON schema validation may be used, for example, to prune any invalid properties

For long page sequences, LLMs may tend to drop some of the source citations. Accordingly, to improve coverage, for longer document portions (e.g., page sequences), an observation stage is added to the process of subgraph extraction where the LLM may be prompted to generate observations for each occurrence of an entity or relationship (or other data point). Graph extraction may then be performed per observation using the LLM. In such a scenario, the input text (e.g., included in the prompt for the document portion) can be restricted by source range or properties. Such an observation stage may meaningfully improve extraction recall.

Accordingly, at the end of the subgraph extraction stage (generating subgraphs for each document portion according to each subgraph schema), there may be zero or more subgraphs corresponding to each combination of document portion and subgraph schema. The nodes of each subgraph may represent entities of the corresponding subgraph schema and may have a document citation attached as an attribute or property of the node. The subgraphs produced for a document can then be merged to generate a (e.g., unified or single) graph representing the document. Thus, in this merging stage, an overall matching process can obtain all the extracted subgraphs from the document as inputs and output the list of matched entities. These matched entities may be merged to generate the unified graph for the document. This merging process can ensure that only one node for matching nodes (e.g., entitles) across subgraphs is included in the resulting unified graph. It will be noted that the term unified or single graph is only intended to mean a graph representing the entirety of the document, such a unified or single graph may (or may not) have (e.g., multiple) disconnected nodes or subgraphs without loss of generality.

This subgraph merging process may utilize one or more entity identification or merging strategies (e.g., algorithms) to identify entities that should be merged (e.g. represented by a single node in a unified graph for the document). The strategy employed may, for example, be tailored to the type of entity of a particular node and may specify matching properties, conditions, strategies, or thresholds for determining when two entities (e.g., nodes) should be identified as matching. Matching conditions can also utilize AND/OR logic across multiple properties to provide flexibility. Moreover, such strategies may be user configurable. Specifically, in some cases nodes from the various subgraphs for the document may be paired (e.g., identified as representing the same entity) using specialized similarity strategies (e.g. fuzzy matching or LLM based matching, fuzzy and LLM matching, numerical matching, etc.). For example, a fuzzy matching strategy may be useful for text similarity while an LLM-based similarity comparison may be implemented for entities where two properties across different entities may be semantically similar. For example, covenant or financial reporting rule clauses in legal documents may be written differently across one or multiple documents but can be semantically similar. LLM-based matching strategies can identify matched entities in such cases where fuzzy matching is insufficient. The configurations for matching strategies can be applied across all entities within subgraphs to indicate how the entities can be matched.

In certain cases, graph neighborhoods or dependency matching may be utilized to determine matching entities. Defining optional dependencies enforces prerequisite matches over dependency relationships, overriding primary matching criteria if dependencies fail to align. For example, a recursive dependency matching algorithm may be used for certain types of entities to further narrow down comparison candidates. Such a matching algorithm may operate recursively for each entity (e.g., label). For entities with dependencies, the process may be recursively applied to the dependent entities. Once matches are found for all dependencies, the algorithm may evaluate eligible nodes with matching dependencies. For entities without dependencies, the algorithm may process all available entities in the graph being evaluated.

In certain embodiments, a normalization may be performed on the entities represented in each subgraph before the matching process is performed. Such a normalization may be utilized by embodiments to account for the fact that LLMs may extract entities from text in unstructured and varied formats. For example, an amount might be expressed as "$1.5M" or "$1,500,000" in different parts of the text. To address this issue, normalization may be performed. Such a normalization process may ensure comparisons are only made between standardized values This normalization may normalize the properties of entities (e.g., nodes in a subgraph) according to one or more transformations such as an amount value transformation, a numeric value transformation, a float value transformation, a date value transformation, a duration or timing conversion and standardization, or other types of transformation.

Once unified graphs are generated for each of the documents being compared, the unified graphs for each document may be compared (matched) to identify entities (nodes) in each of the unified graphs that match (e.g., are to be identified as the same or an equivalent entity). In this comparison stage, when an entity in one unfired graph for a document is identified as matching an entity (node), a new node or edge may be generated in, or between, one or both of the unified graphs to identify these matching entities. These matching entities or discrepancies (e.g., and their citations in one or both of the documents) may then be identified to a user such as by presenting them in a textual or graphical format through an interface.

The determination of which nodes (e.g., entities) in each of the unified graphs are matching may be determined in a similar manner to how entities (e.g., nodes) are identified as matching when merging subgraphs to generate a unified graph. In other words, the comparison of unified graphs may be accomplished using one or more entity identification or merging strategies (e.g., algorithms) to identify entities that should be identified as matching. Again, these strategies may, for example, be tailored to the type of entity of a particular node; may specify matching properties, conditions, strategies, or thresholds for determining when two entities (e.g., nodes) should be identified as matching; may employ logic conditions; may use fuzzy or LLM based matching; may utilize graph neighborhood or dependency matching; may utilize recursive matching, etc. In some cases, the strategy for matching particular entities utilized in the (subgraph) merging stage may be the same or similar to the strategy for that entity in (unified graph) comparison but the thresholds for identifying matching entities in the two stages may be different (e.g., it may be desired to have a higher (or lower) threshold for identifying matching entities when merging subgraphs of the same document than when comparing unified graphs for different documents).

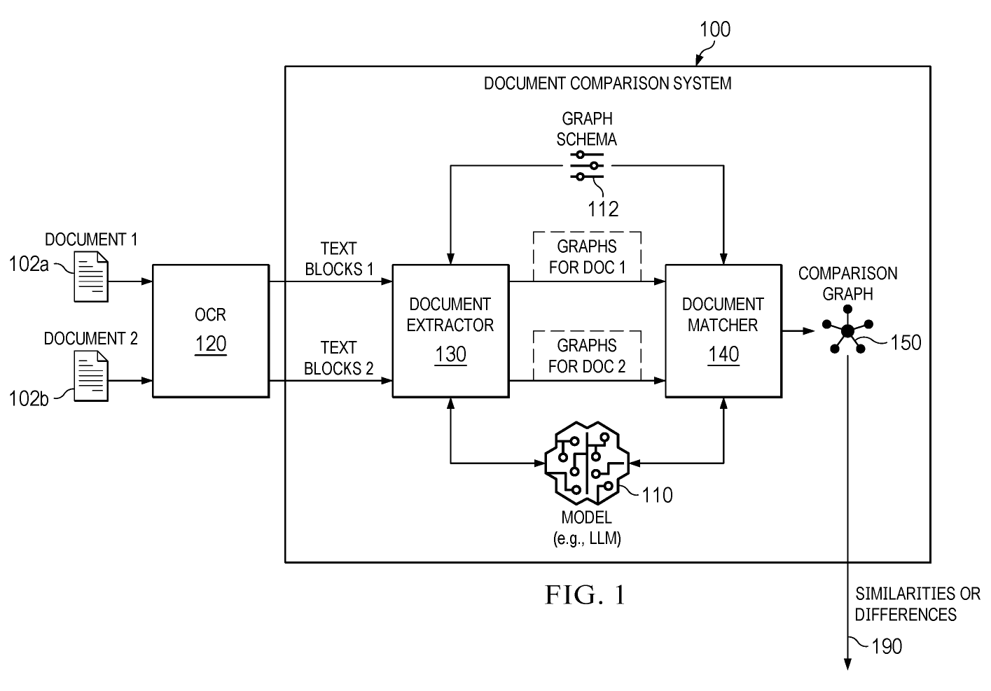

Looking now at FIG. 1, a system for document comparison (e.g., to identify matching entries) is depicted. Here, document comparison system 100 may be adapted to compare two documents 102 (e.g., document 1102a and document 2102b which may be different documents or different portions of the same original document) and generate similarities or differences (e.g., matching or dissimilar entities) 190 which may be presented to a user. Document comparison system 100 includes document extractor 130 and document matcher 140 along with a machine learning model (e.g., an LLM) 110 and a graph schema 112.

Received document 1102a and document 2102b to be compared may be pre-processed to be placed in a textual format if needed. For example, each page may be scanned by an OCR or some other character recognition system 120, if needed, to generate machine readable content for each document 102. In some cases, the text of the document may be rendered or formatted as close as possible to the original layout of the document 102. In the output of this pre-processing stage each line of text of a document output by OCR system 120 may be prefixed by the page and line number to allow data extracted from a document to be easily cited or identified (e.g., by an LLM). Additionally, mappings between the prefixes and text bounding boxes may be maintained to provide citation highlighting graphically if desired.

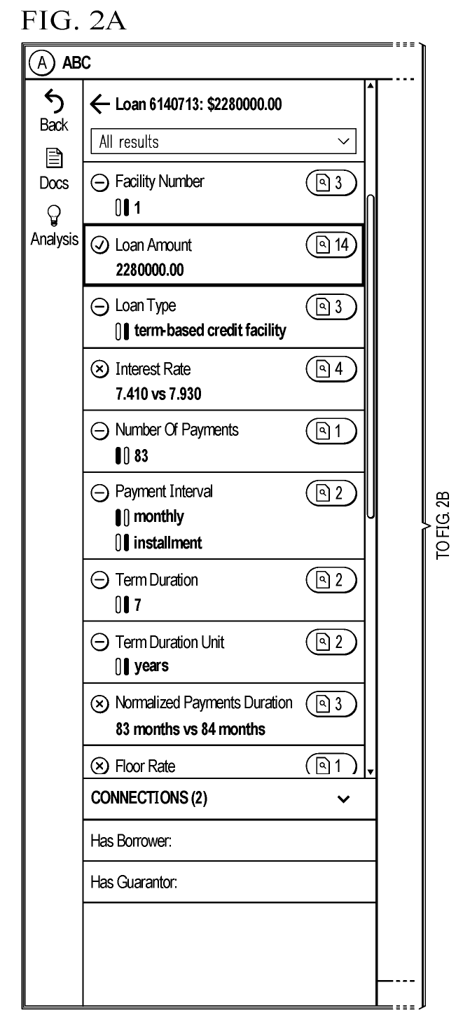

A graph may be produced for each document 102 according to a graph schema 112 by the document extractor 130. Specifically, document extractor 130 may receive the textual (e.g., and citation data) for each document 102 (e.g., from the OCR system 120) and generate one or more graphs for each document 102 using LLM 110. The document matcher 140 may then compare the graphs for each document 102 (e.g., by comparing the two graphs corresponding to each document 102) to produce a comparison graph 150 (e.g., which may relate matching nodes in the graphs for each document 102) which may indicate the differences or similarities across the documents 102. These similarities or differences 190 may be presented to a user through a document comparison application along with other data corresponding to the documents, similarities or differences, such as citations corresponding to the similarities or differences in each of the documents being compared. An example of an interface for the presentation of such similarities or differences across documents is depicted in FIG. 2.

To illustrate embodiments in more detail, in some cases graph schema 112 may be defined for a particular domain for example, based on a set of sample documents or other insights or data. In certain embodiments the graph schema 112 may be subdivided into a number of subgraph schemas. Each of the subgraph schemas may include a portion of the graph schema 112 (e.g., include the entities and relationships of a portion of the graph schema), where the portions of the of the graph schema 112 included in different subgraph schemas may overlap (e.g., two subgraph schemas may include one or more same entities or relationships). This overlap between entities or relationships in the subgraph schemas can be effectively utilized to improve graph merging or comparison (e.g., the overlapping entities or relationships can be used as anchors to merge subgraphs)

Thus, for a document 102, in some embodiments, document extractor 130 may generate a set of subgraphs according to the subgraph schema defined in the graph schema 112 using LLM 110. These generated subgraphs can then be merged into a unified graph for that document 102 by document matcher 140.

Moreover, in certain embodiments, each document 102 may be divided into document portions to aid in graph generation, where each document portion comprises a page sequence of one or more (e.g., sequential) pages of the document 102. Thus, in some embodiments, documents 102 being compared are split into manageable document portions (e.g., page sequences) upon which graph extraction may be independently performed (and where that extraction may be performed in parallel to speed the process).

In some embodiments, graph schema 112 (including any subgraph schemas) are used to split the document 102 into document portions. Specifically, in some embodiments a (page sequencing) prompt instructing LLM 110 to determine page portions (e.g., including page sequences) and including the graph schema 112 (or portions thereof) and the document 102 may be submitted to LLM 110. The page portions (e.g., page sequences) determined by the LLM 110 can then be used as the document portions.

As such, to generate a graph for a document 102, in certain embodiments each document portion of the document 102 can be evaluated according to each subgraph schema of the graph schema 112. For each document portion and subgraph schema, zero or more subgraphs for that document portion and that subgraph schema can be generated based on the text of that document portion and the subgraph schema. The subgraphs generated for each document portion for each subgraph schema can then be merged to produce the graph of the document.

To generate the zero or more subgraphs corresponding to a particular document portion and particular subgraph schema, that subgraph schema and document portion may be provided by document extractor 130 to LLM 110 in a (graph or subgraph generation) prompt where the (graph or subgraph generation) prompt includes an instruction requesting the LLM 110 to perform graph extraction to generate zero or more subgraphs from the included document portion according to the subgraph schema included in the (graph or subgraph generation) prompt.

Additionally, embodiments may employ certain techniques for submitting a subgraph schema in a prompt to the LLM 110 to increase the accuracy of (e.g., sub)graph extraction. In one embodiment, for example, before the subgraph schema is provided to LLM 110 in a prompt, the subgraph schema may be converted or mapped into an equivalent JSON (subgraph) schema representation. A mapping configuration may be used to generate the JSON schema from the corresponding subgraph schema.

Thus, it is the JSON (subgraph) schema (i.e., the JSON representation of the subgraph schema) that is submitted to the LLM 110 in a (graph or subgraph generation) prompt to generate one or more subgraphs from an included document portion. Specifically, the JSON schema, instructions, any examples, and text of the page portions (e.g., page sequences) are all fed as a prompt to the LLM 110. The text of the page portions can be provided in association with line number information corresponding to the page and line number of the original document (e.g., citation data as provided by the OCR system 120 for the text for the document 102). Specifically, each line may be prefixed with a line number and the LLM may be instructed to cite those sources when providing output for entities.

Thus, what is returned (to document extractor 130) from the LLM 110 may be the entities or relationships extracted by the LLM 110 represented in this JSON (subgraph) schema. This JSON representation of the subgraph can then be converted or mapped into a (sub)graph representation according to the graph schema 112 (e.g., the subgraph schema corresponding to the JSON (subgraph) schema submitted in the prompt). In certain embodiments, the LLM 110 may provide (e.g., an array) of entities or relationships (e.g., entity groups) according to the JSON schema. These entities or relationships (e.g., entity groups) are then converted into (sub)graphs using the relationship definitions of the mapping configurations. Before performing this mapping or conversion, validations or pruning may be performed on the JSON representation of the extracted entities or relations. JSON schema validation may be used, for example, to prune any invalid properties

To improve coverage, in certain embodiments, for longer document portions (e.g., page sequences), an observation stage is added to the process of subgraph extraction where the LLM 110 may be prompted to generate observations for each occurrence of an entity or relationship (or other data point). Graph extraction may then be performed per observation using the LLM 110. In such a scenario, the input text (e.g., included in the prompt for the document portion) can be restricted by source range or properties. Such an observation stage may meaningfully improve extraction recall.

Accordingly, at the end of the subgraph extraction stage (generating subgraphs for each document portion according to each subgraph schema), there may be zero or more subgraphs corresponding to each combination of document portion and subgraph schema. The nodes of each subgraph may represent entities of the corresponding subgraph schema and may have a document citation attached as an attribute or property of the node. The subgraphs produced for a document 102 can then be merged by document matcher 140 to generate a (e.g., unified or single) graph representing the document 102. Thus, in this merging stage, an overall matching process can obtain all the extracted subgraphs from the document as inputs and output the list of matched entities. These matched entities may be merged to generate the unified graph for the document 102. This merging process can ensure that only one node for matching nodes (e.g., entitles) across subgraphs is included in the resulting unified graph for the document 102.

This subgraph merging process may utilize one or more entity identification or merging strategies (e.g., algorithms) to identify entities that should be merged (e.g. represented by a single node in a unified graph for the document). The strategy employed may, for example, be tailored to the type of entity of a particular node and may specify matching properties, conditions, strategies, or thresholds for determining when two entities (e.g., nodes) should be identified as matching. Matching conditions can also utilize AND/OR logic across multiple properties to provide flexibility. Moreover, such strategies may be user configurable. Specifically, in some cases nodes from the various subgraphs for the document may be paired (e.g., identified as representing the same entity) using specialized similarity strategies (e.g. fuzzy matching or LLM based matching, fuzzy and LLM matching, numerical matching, etc.). For example, a fuzzy matching strategy may be useful for text similarity while an LLM-based similarity comparison may be implemented for entities where two properties across different entities may be semantically similar. For example, covenant or financial reporting rule clauses in legal documents may be written differently across one or multiple documents but can be semantically similar. LLM-based matching strategies can identify matched entities in such cases where fuzzy matching is insufficient. The configurations for matching strategies can be applied across all entities within subgraphs to indicate how the entities can be matched.

In certain cases, graph neighborhoods or dependency matching may be utilized to determine matching entities. Defining optional dependencies enforces prerequisite matches over dependency relationships, overriding primary matching criteria if dependencies fail to align. For example, a recursive dependency matching algorithm may be used for certain types of entities to further narrow down comparison candidates. Such a matching algorithm may operate recursively for each entity (e.g., label). For entities with dependencies, the process may be recursively applied to the dependent entities. Once matches are found for all dependencies, the algorithm may evaluate eligible nodes with matching dependencies. For entities without dependencies, the algorithm may process all available entities in the graph being evaluated. In certain embodiments, a normalization may also be performed on the entities represented in each subgraph before the matching process is performed.

Once unified graphs are generated for each of the documents being compared, the unified graphs for each document 102 may be compared (matched) by document matcher 140 generate a comparison graph 150 that identifies entities (nodes) in each of the unified graph for each document 102 that match (e.g., are to be identified as the same entity). In this comparison stage, to generate comparison graph 150, when an entity in one unfired graph for a document is identified as matching an entity (node), a new node or edge may be generated in, or between, one or both of the unified graphs to identify these matching entities. These matching entities or discrepancies (e.g., and their citations in one or both of the documents) may then be identified to a user such as by presenting them in a textual or graphical format through an interface.

The determination of which nodes (e.g., entities) in each of the unified graphs are matching may be determined in a similar manner to how entities (e.g., nodes) are identified as matching when merging subgraphs to generate a unified graph. In other words, the comparison of unified graphs may be accomplished using one or more entity identification or merging strategies (e.g., algorithms) to identify entities that should be identified as matching. Again, these strategies may, for example, be tailored to the type of entity of a particular node; may specify matching properties, conditions, strategies, or thresholds for determining when two entities (e.g., nodes) should be identified as matching; may employ logic conditions; may use fuzzy or LLM based matching; may utilize graph neighborhood or dependency matching; may utilize recursive matching, etc. In some cases, the strategy for matching particular entities utilized in the (subgraph) merging stage may be the same or similar to the strategy for that entity in (unified graph) comparison but the thresholds for identifying matching entities in the two stages may be different (e.g., it may be desired to have a higher (or lower) threshold for identifying matching entities when merging subgraphs of the same document than when comparing unified graphs for different documents).

As can be seen then, by utilizing embodiments as disclosed, users can easily check (e.g., large) documents for discrepancies and compare them. Embodiments can scale to documents with hundreds (or more) of pages and compare any two documents with the desired data points. While certain document comparison technologies may offer discrepancy analysis they are limited to standard and singular data points within a single document, whereas embodiments can extract and compare highly interdependent data points across two documents and, in particular, specific data points desired by the user. Moreover, embodiments may have significant efficiency and speed benefits, exhibiting document comparison times that may be up to 50% less than other available document comparison systems, while also being more accurate with a greater degree of granularity with respect to the data points extracted and compared.

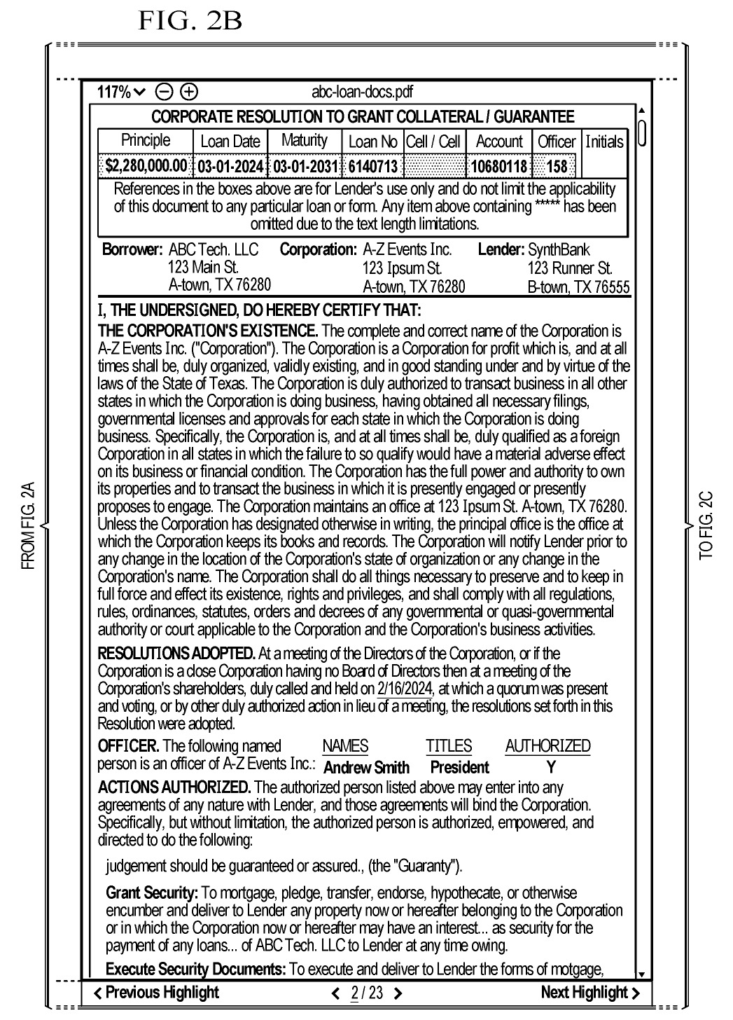

Moving now to FIG. 3, a flow diagram depicting the operation of certain embodiments for document comparison is presented. Initially, a graph schema may be determined, defined, or obtained (STEP 310). This graph schema may comprise a definition of nodes (e.g., representing entities) and relationships (e.g., between the node types) that are associated with a user’s domain or context. The nodes and relationships may have definitional or descriptive properties or attributes associated with them. The graph schema may be divided into a number of subgraphs schemas (e.g., each subgraph schema may comprise a portion of the graph schema including the nodes and relationships of that portion).

Two documents to be compared may be received and the content (e.g., text) of each document obtained (STEP 320). Each of the documents may be processed, if needed, to put the text of the document in machine readable format such as by text extraction (OCR) or the like. The content for the document may also include citations (e.g., page or line, graphical references, etc.) associated with the extracted text.

Each document (e.g., the content of each document as produced from the text extraction) can then be split into one or more document portions (e.g., page sequences) (STEP 330). In one embodiment, these document portions (e.g., page sequences) may be determined based on the subgraph schemas of the determined graph schema. It will be noted then, that in some embodiments, there may be one set of document portions to use for graph extraction while in other embodiments the document may be split differently for each subgraph schema. Thus, there may be a different set of document portions associated with each subgraph schema, and the corresponding document portion for that subgraph may be used when performing graph extractions for each subgraph schema.

Graph extraction can then be performed for each document to generate a document graph. Specifically, in certain embodiments subgraph extraction may be performed on each document portion for each subgraph schema to generate a corresponding (zero or more) subgraphs from each document portion for each subgraph schema (STEP 340). In other words, for each document portion, a subgraph extraction may be performed on that portion for each of the subgraph schemas of the graph schema.

In some embodiments, an LLM may be utilized to perform such subgraph extraction for each document portion and subgraph schema by prompting the LLM with the subgraph schema and the portion along with a prompt instructing the LLM to extract a graph of that portion according to the subgraph schema. In order to perform this subgraph extraction, in one embodiment a JavaScript Object Notation (JSON) mapping may be utilized. This JSON mapping may define a mapping between nodes and relationships as defined in the subgraph schema with corresponding JSON. In this manner, JSON describing or defining the subgraph schema may be provided to the LLM along with the document portion and the prompt or other instructions. The LLM can then generate JSON defining or describing the subgraph the LLM has extracted from the document portion in accordance with that subgraph schema. The JSON produced by the LLM can then be mapped (e.g., in the same manner using the JSON mapping) to that subgraph schema to define the subgraph produced for that combination of document portion and subgraph schema.

At this point then, there are a number of subgraphs for a document, each subgraph corresponding to a subgraph schema and document portion. These subgraphs generated for the document can then be merged into a unified document graph for the document (STEP 350). This merging may be accomplished using a rules based matching or merging algorithm that defines how subgraphs, nodes (e.g., entities) or relationships are to be merged (e.g., combined, deleted, added, etc.). This merging may be entity specific, defining how entities of the same type (e.g., node corresponding to those entities) are to be compared to determine if those nodes represent the same entity, such that different matching strategies, data, thresholds, etc. may be utilized when comparing or otherwise evaluating different types of entities to determine if those entities (e.g., nodes representing those entities) should be merged.

Thus, at the end of this merging stage, there may be two (unified) document graphs, one document graph representing each of the documents. These unified document graphs may be compared to determine the similarities or differences between the two documents corresponding to those document graphs (STEP 360). The comparison may result, for example, in a comparison graph, where that comparison graph may be a unification of the unified graphs for each document. In some cases, the same merging or matching algorithm used to merge subgraphs for a document may be utilized to compare or merge the two unified document graphs. It will be understood, however, that the merging configuration (e.g., the rules, data, matching strategies, thresholds, etc.) employed for utilizing that matching or merging algorithm in a document comparison context (e.g., as applied to two document graphs) may be the same, or may be different) that than the merging configuration applied when merging subgraphs for a single document.

To illustrate embodiments in more detail, embodiments of a document comparison system may comprise several stages, including system configuration, document preprocessing, document extraction, and graph merging and comparison. Turning first to system configuration, in the first stage of embodiments, desired data points are gathered from a user along with sample document sets. Using the desired data points, a graph schema for that user or enterprise is constructed that describes the data points and the dependencies between them. Next, the graph schema may be broken into a plurality of subgraph schemas that can be used to (e.g., independently) extract groups of data points. A configuration may be created per subgraph including mappings between the subgraph schema and a JSON schema, LLM instructions, and examples.

Once documents (e.g., for comparison) are uploaded into the system or otherwise obtained, in a document preprocessing stage, each page is scanned by an OCR system, and the text is rendered as close as possible to the original layout. Each line of text is prefixed by the page and line number to allow the LLM to conveniently cite extractions. Separately, mappings between the prefixes and text bounding boxes are maintained to provide citation highlighting.

Document extraction can then be performed. This document extraction may have several sub-stages. First, the subgraph schema is used to split a document into page sequences from which data points can be independently extracted. Next, the subgraph schema is mapped to a JSON schema that, combined with the instructions, examples, and input text, is fed to the LLM to generate JSON extractions. After performing validations and pruning, the JSON extractions are converted into graph representations using the configuration defined in the system. For longer page sequences, an observation stage may be added to the process where the LLM is asked to generate observations for each occurrence of a data point, and then extraction is performed per observation. The observation stage may meaningfully improve extraction recall. At the end of this stage, multiple subgraphs per page sequence per subgraph schema may exist.

Graph merging and comparison can then be performed. Both graph comparison and merging may use the same matching algorithm internally. Nodes from the various subgraphs are paired using specialized similarity strategies that are (e.g., user) configurable, e.g. fuzzy matching and LLM based matching. In addition, a recursive dependency matching algorithm may be used for certain types of data points to further narrow down comparison candidates. In the merging stage the matched nodes are merged, whereas in the comparison stage, new nodes and edges are created to identify the matches.

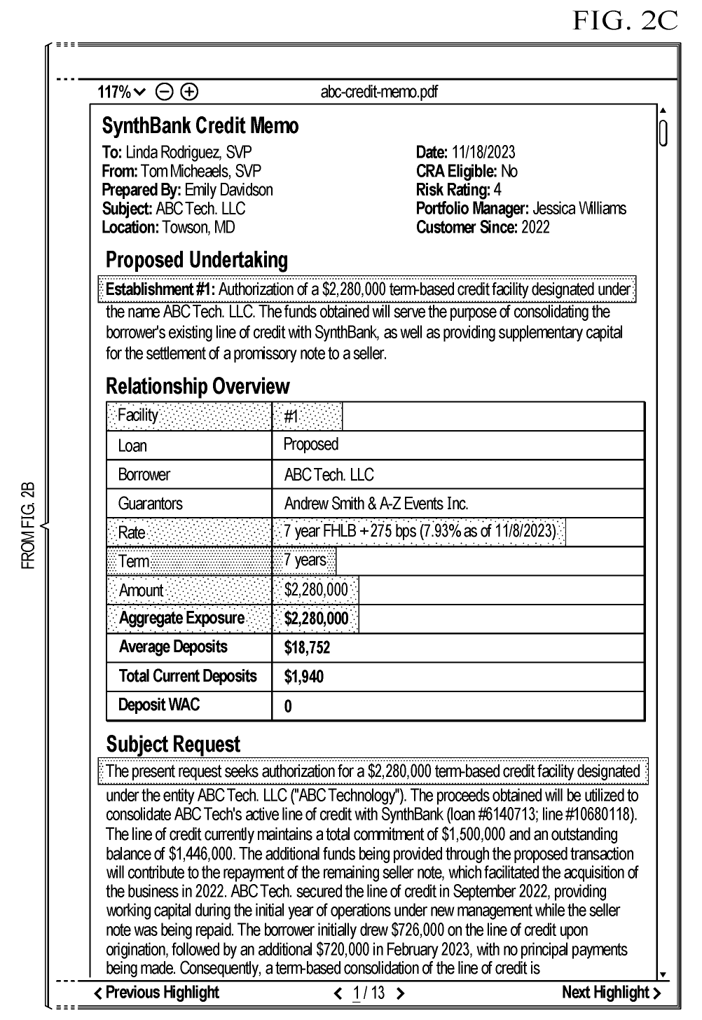

It may now be useful to describe embodiments of subgraph extraction (e.g., from long or complex documents) in more detail. Attention is thus directed now to FIG. 4, depicting one example of a portion of a simple graph schema and subgraph schemas derived from a loan application based context. User or enterprise specific graph schemas can be used to directly extract graphs from document text, but the results may be unreliable and lack coverage. Instead, extraction may be broken down into phases in embodiments. In graph schema partitioning the graph schema is partitioned into subgraph schemas such that documents or portions thereof can be independently processed according to each of these subgraph schemas.

In graph schema partitioning, the graph schema is partitioned into subgraph schemas that may be independent of (or related to) each other. These subgraph schemas may include overlapping entities (e.g., entities that may be included in two or more subgraphs). These overlapping entities may be used as anchors in the merging or comparison process (e.g., to merge subgraphs or compare unified graphs). As depicted in the simplified example of FIG. 4 there are three subgraph schemas 402: LoanFacility + Person + Business; ReportingRule + Person + Business; and Covenant + Business. The idea here is that entities related to each subgraph schema occur independently in the document text and can be extracted in parallel. The overlapping Person and Business entities are then used as anchors to merge subgraphs.

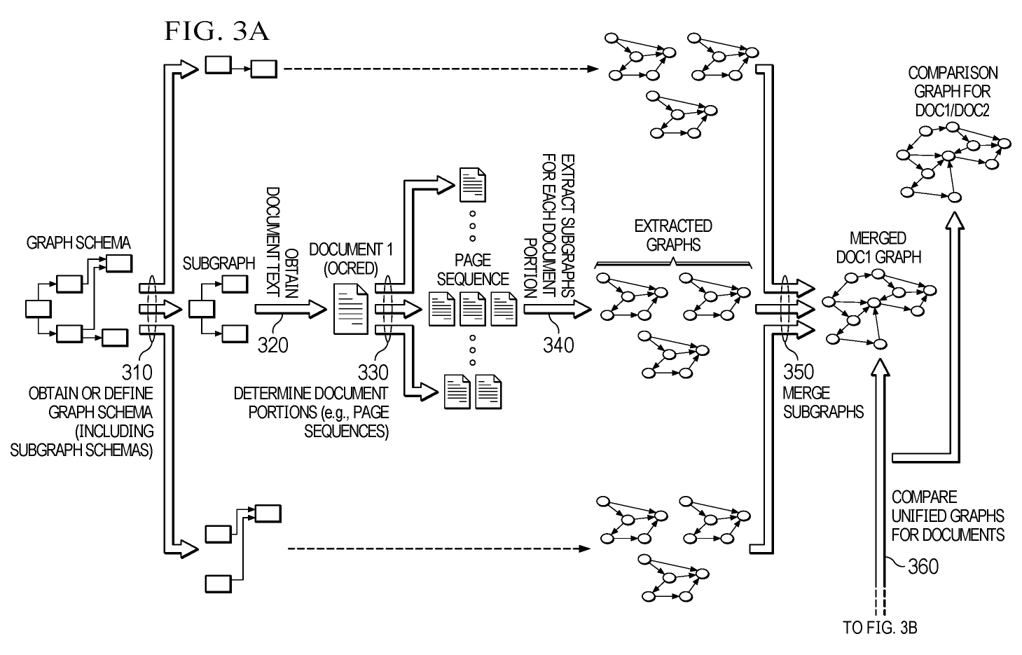

As discussed, in certain cases documents can be quite large and may not fit into an LLM’s input (e.g., a context window). Even if a given document does fit into the LLM input, LLMs tend to skip information while extracting from very large contexts. Hence, documents may be split into manageable page sequences upon which (sub)graph extraction can be performed independently. FIG. 5 depicts a flow diagram of one embodiment of method for document splitting. In these types of embodiments, an LLM may be provided the subgraph schema and examples to select page sequences. The LLM may be instructed to take into consideration content spillovers from previous pages.

Here, for example, a dialog may be started with an LLM using a starting page (x) of a document, the graph schema (or one or more subgraph schemas) and any desired examples (e.g., associated with document splitting) (STEP 510). If the page does not include a data point (e.g., content corresponding to an entity in a subgraph schema), a new dialog can be started with the next subsequent page serving as an initial page or another subgraph schema (No Branch of STEP 520 and STEP 530). If the page does include a data point (Yes Branch of STEP 520) the (next) subsequent page can be added to the dialog (STEP 540) and evaluated to determine if the next page includes the data point (STEP 550). If the next page does include a data point (Yes Branch of STEP 550) a count can be incremented and the next page added to the dialog (STEP 540). The adding of pages continues until a page is added to the dialog that does not include the data point (No Branch of STEP 550). At this point that document portion (e.g., the page range defining the pages of the document corresponding to that document portion) can be returned (STEP 560).

Using these document portions and subgraph schemas, graphs (e.g., subgraphs) may be extracted from the document portions determined for the documents being compared. Specifically, subgraphs are extracted from the document page sequences of the document portions based on the subgraph schemas.

As discussed, this graph extraction may be done indirectly. LLMs may struggle with directly extracting graphs from page sequences, especially when there are many different entities. Instead, according to embodiments, before they are fed to the LLM, the subgraph schemas are converted into equivalent JSON schema representations that may be better supported by LLMs.

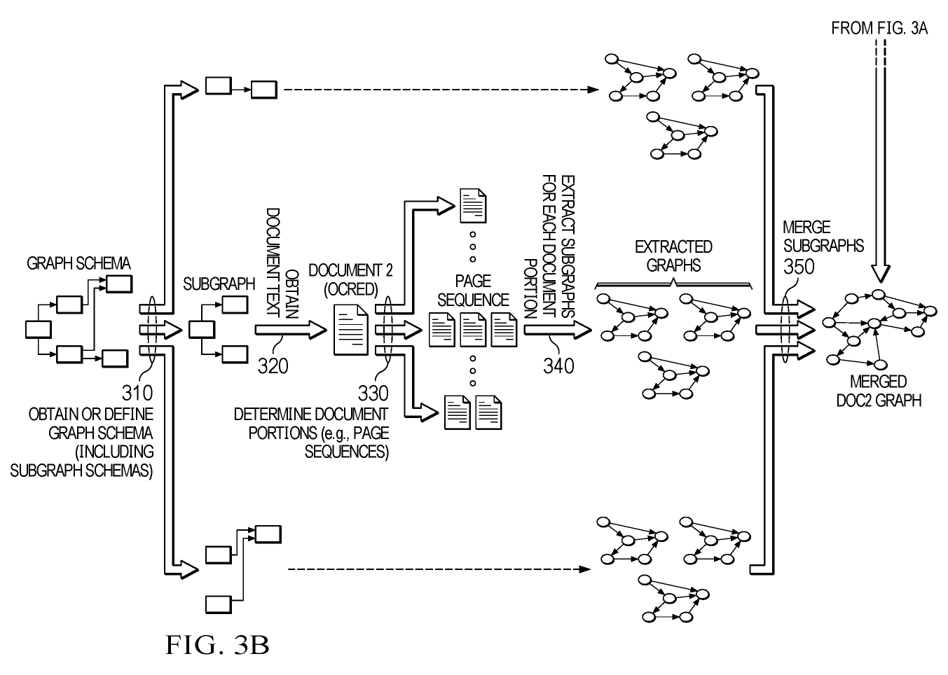

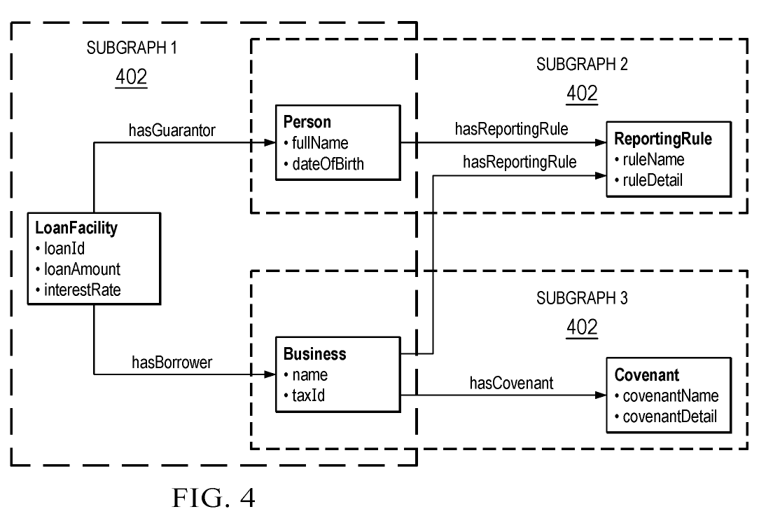

Such mapping of subgraph schema to a corresponding JSON schema is depicted in FIG. 6 while an example of a mapping configuration is illustrated in FIG. 7. In this example, a mapping configuration is used to generate the JSON schema on the right. Using a JSON schema has several benefits, like the ability to restrict types and apply required properties. In some embodiments, the format may be similar to API schema definitions but may have certain enhancements. In some cases, property descriptions will default to the referenced graph schema unless they are overridden (e.g., like the Business name).

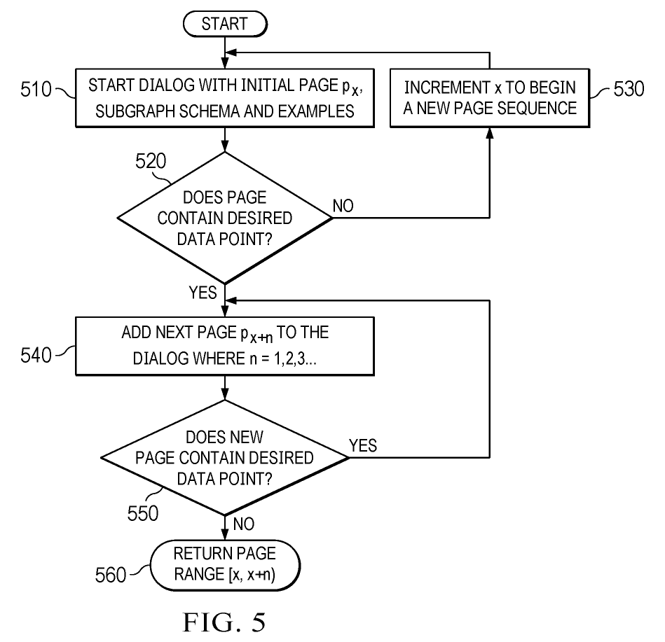

The JSON schema, instructions, examples, and page sequence text may all be fed as a prompt to the LLM which outputs an array of entity groups. These groups are then converted into subgraphs using the relationship definitions of the mapping configurations as illustrated in FIG. 8. In some cases, before the conversion JSON schema validation may be used to determine or prune any invalid properties.

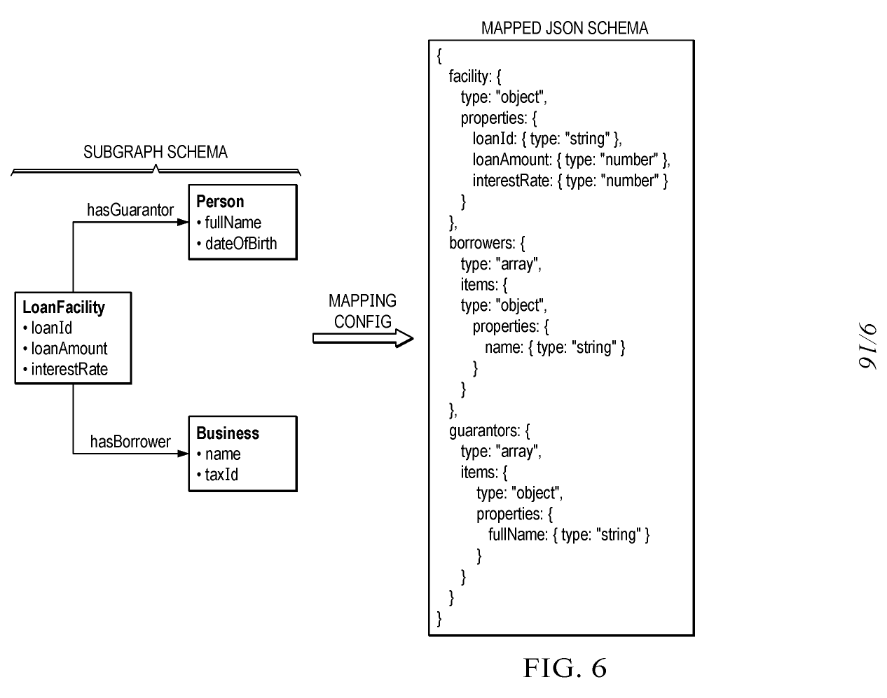

For long page sequences, LLMs may tend to drop some of the source citations. To improve coverage, embodiments may add an additional observation stage. Extraction is then performed for each observation and the input text is restricted by source range and properties. An example observation is depicted in FIG. 9.

Once the subgraphs for each document are generated, they may be merged to create a document graph for each document. The document graphs for each of these documents can then be compared. The merging or comparison of subgraphs or graphs may include normalization and standardization. LLMs extract values from text in unstructured and varied formats. For example, an amount might be expressed as "$1.5M" or "$1,500,000" in different parts of the text.

To address this inconsistency, a normalization step may be implemented before the matching process, ensuring comparisons are only made between standardized values. Normalizations for each entity property are added to the configuration, if desired. Examples of these transformation functions may include, amount value transformation, numeric value transformation, float value transformation, date value transformation, duration conversion and standardization, etc. Other types of transformations are possible and are fully contemplated herein.

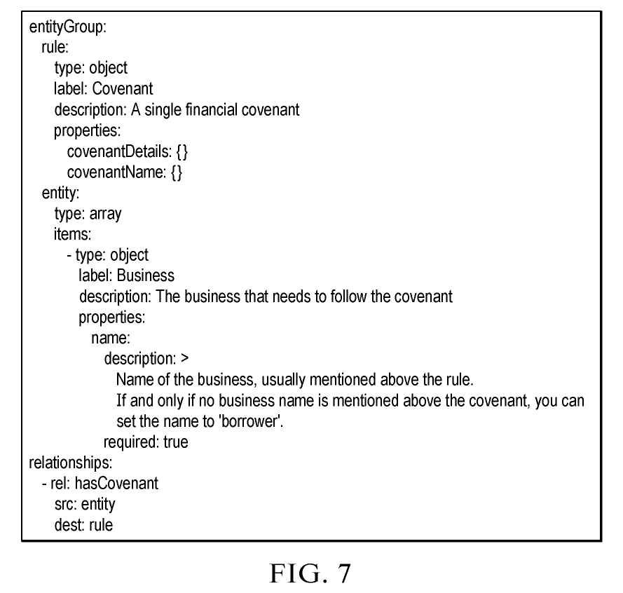

A rule-based matching algorithm is implemented for subgraph merging and graph comparison. This algorithm facilitates the creation of a unified document knowledge graph through the merging process and enables the comparison of graphs extracted from multiple documents to identify matches and discrepancies. FIG. 10 graphically depicts one embodiment of matching using a merging configuration.

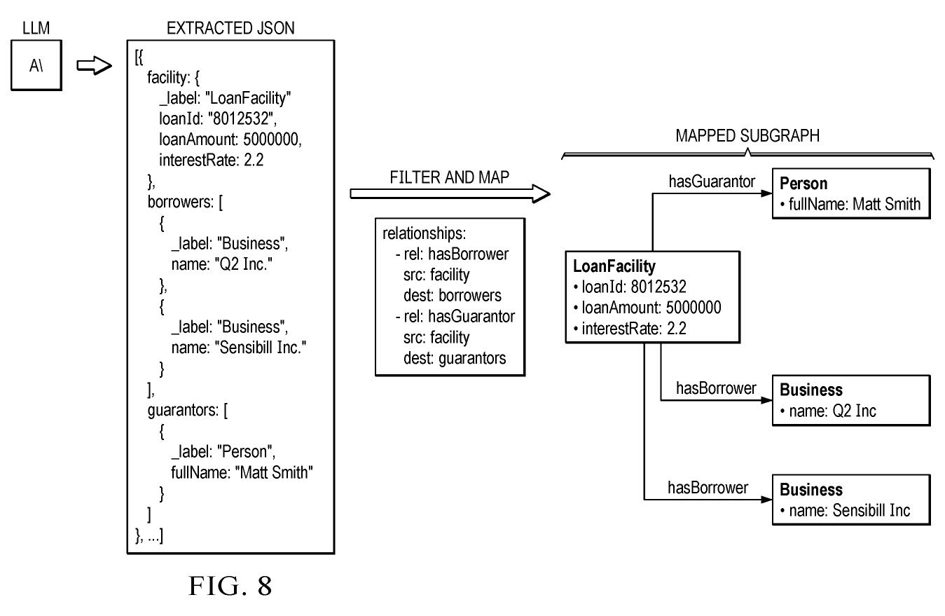

Flexible merging and comparison configurations define how subgraphs interconnect in an explainable way. Configurations for each entity specify matching properties, strategies, and acceptance thresholds may be defined. Diverse strategies such as fuzzy matching, LLM-based matching, fuzzy + LLM matching and numerical matching may be employed for effective entity linking and to enhance subgraph connections. The configurations can be applied across all entities within subgraphs to indicate how the entities can be matched. Matching conditions can also utilize AND/OR logic across multiple properties to provide flexibility when required. FIG. 11 shows an example merging configuration that instructs that “Business” entities should get matched based on a 99% or higher fuzzy match of the name property associated with the node representing that entity.

While fuzzy matching strategy is useful for text similarity, LLM-based similarity comparison may be implemented for cases where two properties across different entities are semantically similar. For example, covenant or financial reporting rule clauses in legal documents may be written differently across one or multiple documents but can be semantically similar. LLM-based matching strategies can identify matched entities in such cases where fuzzy matching is insufficient.

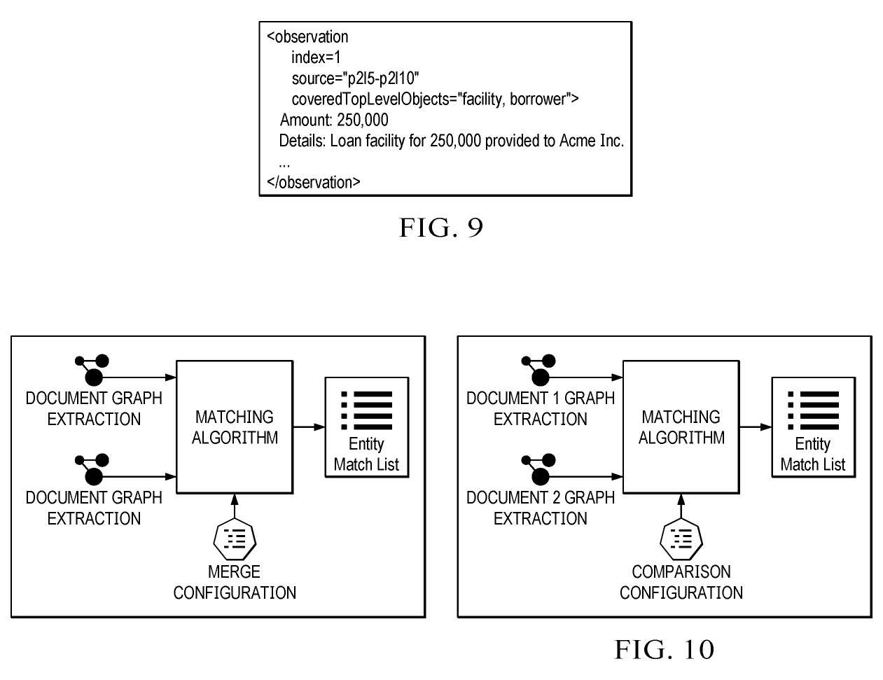

In the merging stage where subgraphs determined for a document are merged, in one embodiment, the matching algorithm receives all the extracted subgraphs from the document as inputs and outputs the list of matched entities that can merge (or merges these entities (e.g., the nodes for those entities) to create a document graph for the document. FIG. 12 depicts an example of two Business entities (e.g., nodes representing those business entities) getting merged based on their name property matching.

In some cases, dependencies for entities being compared (e.g., nodes related to the nodes representing entities being compared) may be utilized in the matching or merging process. Defining optional dependencies enforces prerequisite matches over dependency relationships, overriding primary matching criteria if dependencies fail to align. For example, in a dependency matching process the dependencies of each node may be recursively checked before it is attempting to merge those nodes. Such dependencies may be defined per node in the configurations (e.g., of the nodes). Once nodes without any dependencies are reached, an attempt to match them can be made. If that matching is successful, a move downward is made and an attempt to match the nodes that depend on those upper-level nodes is made. This approach prevents merging nodes that may have similar properties but different dependencies. For example, even if two loans have similar matching properties in a document, they would not be merged if their borrowers (as represented by a dependent node or a node on which a node representing the loan depends) are different.

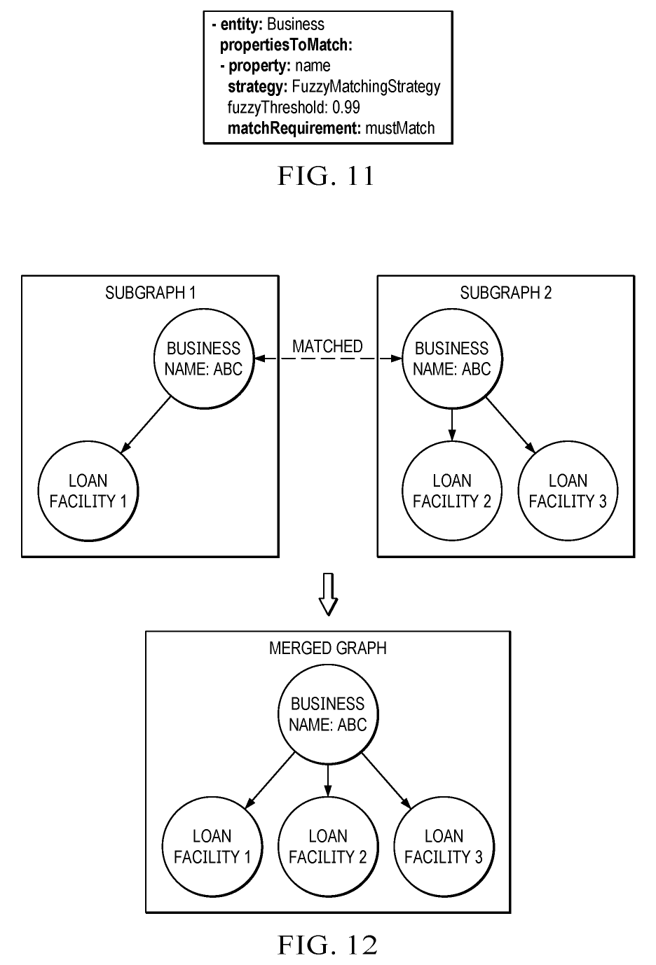

FIG. 13 depicts one embodiment of a matching process for an entity with a recursive dependency matching. Initially, entities may be filtered (e.g., by dependency labels such as properties or attributes) for matching (STEP 1310). The configuration for matching an entity of that type can then be loaded (STEP 1320). It can then be determined if the node(s) for that entity being matched have any dependency (STEP 1340). If the node(s) have dependencies (Yes Branch of STEP 1340) it can be determined if the dependencies are matched (STEP 1350). If the dependencies are not matched dependencies (No Branch of STEP 1350), the dependency labels may be obtained (STEP 1330) and used in the filtering process for determining entities to match (STEP 1310). If the dependencies do match, the matching algorithm can be run on the eligible nodes (STEP 1360) to determine if the entities represented by those nodes match (e.g., is a similarity score for those entities above a threshold) the node(s). If the node(s) do not have dependencies (No Branch of STEP 1340) the matching algorithm can be run on the eligible nodes (STEP 1360) at that point to determine if the entities represented by those nodes match.

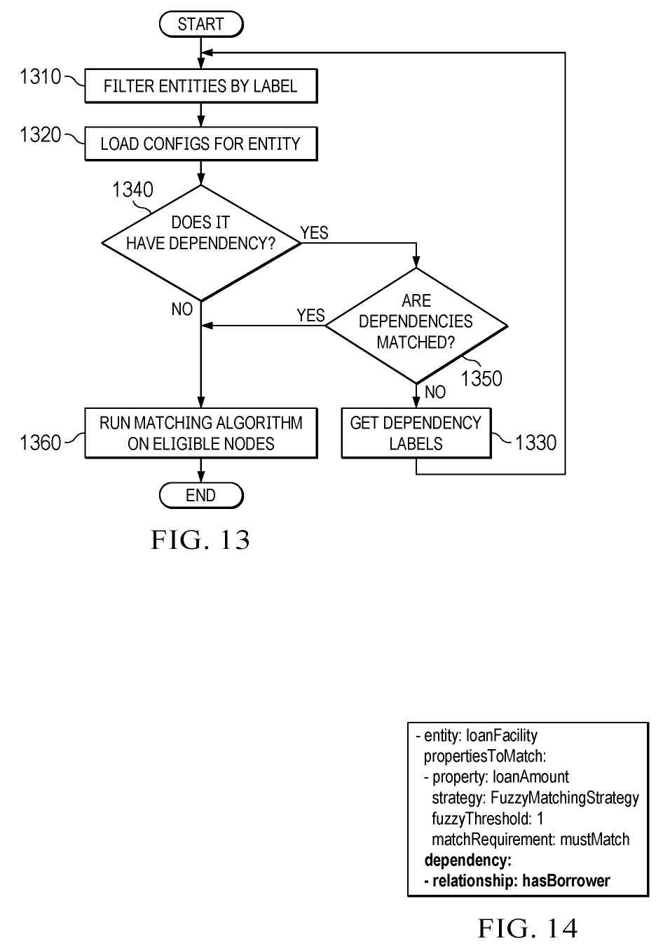

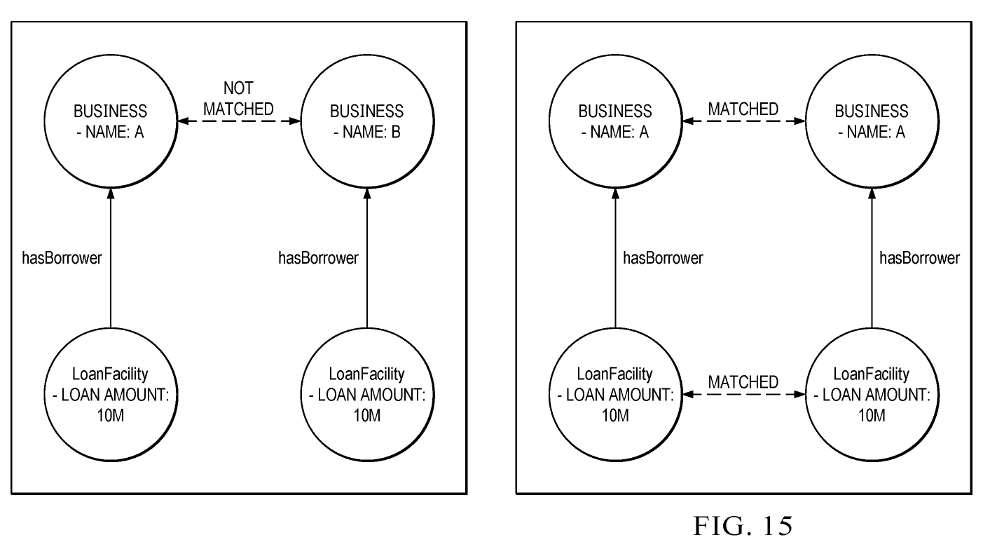

To illustrate an example, the configuration shown on FIG. 14 defines a "hasBorrower" dependency for the LoanFacility entity. This configuration instructs the matching algorithm to ensure borrowers of loan facility entities are matched first. This approach prevents incorrect matching of loan facilities for different borrowers, even if properties like loan amount match. FIG. 15 illustrates examples of "LoanFacility" entities with matching properties and demonstrates how these entities are matched or not matched based on the matching status of their dependencies (borrower). In this example, entities may not be matched or merged because of their dependencies not matching (depicted on the left of the figure) while entities may be matched or merged when dependencies match (depicted on the right of the figure).

Embodiments of this matching algorithm may also be employed in the graph comparison stage (e.g., with the same or a different merging configuration), where the matching algorithm may be utilized to analyze the entities across the two extracted document graphs for the documents being compared. The algorithm identifies matching entity pairs and compares their properties to determine exact matches or discrepancies. This process provides the end user with valuable insights into the consistency of extracted values across documents.

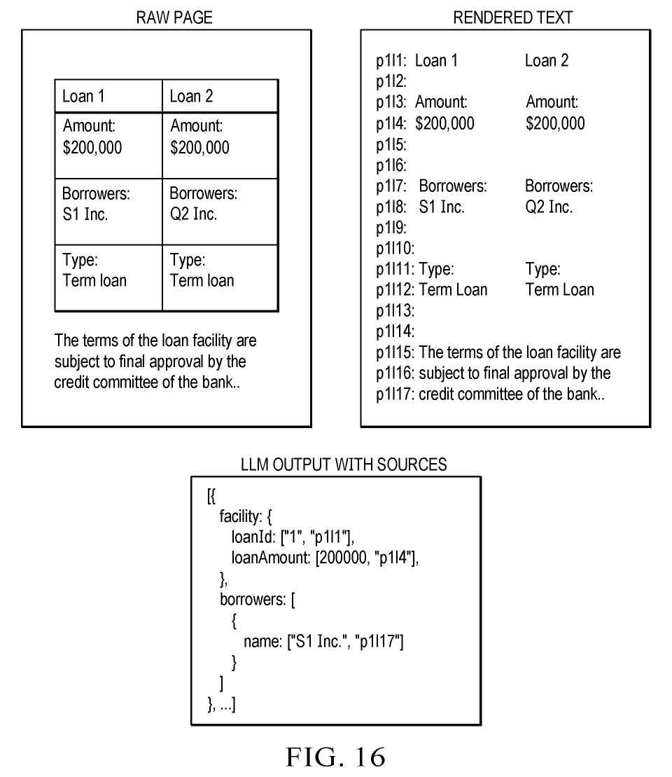

Embodiments can then present data associated with this document comparison to a user through an interface as discussed above. In some embodiments, source citations from the documents (e.g., associated with the similarities or differences of the two documents) may be presented to a user through the interface as well. These source citations may be determined using marking of input text. An important feature of embodiments is their ability to highlight source citations on documents. Existing techniques for source citations usually cite at the page level or provide text that needs to be searched on a page. This can be problematic if there are multiple occurrences of a phrase. Instead, embodiments may provide line number information to the LLM when performing extraction, etc. The page’s OCR output is rendered in text to be as close as possible to the original layout. Each line is prefixed with a line number and the LLM is instructed to cite those sources as illustrated in FIG. 16. Separately, the line numbers are mapped to bounding boxes which can later be used to highlight citations in the document (e.g., when presenting document comparisons to a user).

Those skilled in the relevant art will appreciate that the invention can be implemented or practiced with other computer system configurations, including without limitation multi-processor systems, network devices, mini-computers, mainframe computers, data processors, and the like. The invention can be embodied in a computer or data processor that is specifically programmed, configured, or constructed to perform the functions described in detail herein. The invention can also be employed in distributed computing environments, where tasks or modules are performed by remote processing devices, which are linked through a communications network such as a local area network (LAN), wide area network (WAN), and/or the Internet. In a distributed computing environment, program modules or subroutines may be located in both local and remote memory storage devices. These program modules or subroutines may, for example, be stored or distributed on computer-readable media, including magnetic and optically readable and removable computer discs, stored as firmware in chips, as well as distributed electronically over the Internet or over other networks (including wireless networks). Example chips may include Electrically Erasable Programmable Read-Only Memory (EEPROM) chips. Embodiments discussed herein can be implemented in suitable instructions that may reside on a non-transitory computer readable medium, hardware circuitry or the like, or any combination and that may be translatable by one or more server machines.

ROM, RAM, and HD are computer memories for storing computer-executable instructions executable by the CPU or capable of being compiled or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” is not limited to ROM, RAM, and HD and can include any type of data storage medium that can be read by a processor. A “computer-readable medium” may be any type of data storage medium that can store computer instructions that are translatable by a processor. Examples of computer-readable media can include, but are not limited to, volatile and non-volatile computer memories and storage devices such as random access memories, read-only memories, hard drives, data cartridges, direct access storage device arrays, magnetic tapes, floppy diskettes, flash memory drives, optical data storage devices, compact-disc read-only memories, and other appropriate computer memories and data storage devices. Thus, a computer-readable medium may refer to a data cartridge, a data backup magnetic tape, a floppy diskette, a flash memory drive, an optical data storage drive, a CD-ROM, ROM, RAM, HD, or the like. Data may be stored in a single storage medium or distributed through multiple storage mediums, and may reside in a single database or multiple databases (or other data storage).

A “processor” includes any hardware system, mechanism or component that processes data, signals or other information. A processor can include a system with a central processing unit, multiple processing units, dedicated circuitry for achieving functionality, or other systems. Processing need not be limited to a geographic location or have temporal limitations. For example, a processor can perform its functions in “real-time,” “offline,” in a “batch mode,” etc. Portions of processing can be performed at different times and at different locations, by different (or the same) processing systems.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments can be implemented in a computer communicatively coupled to a network (for example, the Internet, an intranet, an internet, a WAN, a LAN, a SAN, etc.), another computer, or in a standalone computer. As is known to those skilled in the art, the computer can include a central processing unit CPU or other processor, memory (e.g., primary or secondary memory such as RAM, ROM, HD or other computer readable medium for the persistent or temporary storage of instructions and data) and an input/output (“I/O”) device. The I/O device can include a keyboard, monitor, printer, electronic pointing device (for example, mouse, trackball, stylus, etc.), touch screen or the like. In embodiments, the computer has access to at least one database on the same hardware or over the network.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only to those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated otherwise. Also, as used in the description herein and throughout the meaning of “in” includes “in” and “on” unless the context clearly dictates otherwise.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the figures can also be implemented in a more separated or integrated manner or even removed or rendered as inoperable in certain cases, as is useful in accordance with a particular application. Additionally, any signal arrows in the figures should be considered only as exemplary, and not limiting, unless otherwise specifically noted.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

In the foregoing specification, the invention has been described with reference to specific embodiments. However, one of ordinary skill in the art appreciates that various modifications and changes can be made without departing from the scope of the invention. Accordingly, the specification, including the Summary, Abstract and figures are to be regarded in an illustrative rather than a restrictive sense, and all such modifications are intended to be included within the scope of invention.

As one skilled in the art can appreciate, a computer program product implementing an embodiment disclosed herein may comprise a non-transitory computer readable medium storing computer instructions executable by one or more processors in a computing environment. The computer readable medium can be, by way of example only but not by limitation, an electronic, magnetic, optical or other machine-readable medium. Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices.

Particular routines can execute on a single processor or multiple processors. Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. Functions, routines, methods, steps and operations described herein can be performed in hardware, software, firmware or any combination thereof.

It will also be appreciated that one or more of the elements depicted in the drawings/figures can be implemented in a more separated or integrated manner or even removed or rendered as inoperable in certain cases, as is useful in accordance with a particular application. Additionally, any signal arrows in the drawings/figures should be considered only as exemplary, and not limiting, unless otherwise specifically noted.

What is claimed is:

1. A system for comparing documents, comprising:
a processor; and
a non-transitory computer readable medium, comprising instructions for:
receiving a plurality of documents to be compared;
obtaining a graph schema defining entity types and relationships, the graph schema being subdivided into one or more subgraph schemas;
for each document:
generating a subgraph associated with each of the one or more subgraph schemas by:
providing a representation of that subgraph schema to a large language model (LLM) in association with text of the document,
receiving, from the LLM, entity data corresponding to the subgraph schema, and
generating the subgraph based on the entity data received from the LLM;
merging the plurality of subgraphs generated for the document to produce a unified graph representation of the document; and
comparing the unified graph representations of the plurality of documents to identify matching entities associated with the plurality of documents.

2. The system of claim 1, wherein the one or more subgraph schemas define overlapping entity types, and wherein the plurality of subgraphs are merged is based on the overlapping entities.

3. The system of claim 1, wherein generating the subgraph for each of the one or more subgraph schema comprises dividing each document into document portions and generating the subgraph for each document portion.

4. The system of claim 1, wherein providing the representation of that subgraph schema to the LLM comprises converting the subgraph schema into a structured representation.

5. The system of claim 4, wherein the structured representation is in a JSON format.

6. The system of claim 4, wherein generating the subgraph comprises receiving the entity data from the LLM according to the structured representation and mapping the received entity data to nodes and edges of the subgraph according to the subgraph schema.

7. The system of claim 1, wherein generating the subgraph further comprises providing citation data associated with the text to the LLM and the received entity data includes citation data, and wherein the subgraph generated based on the entity data includes citation data for entities in nodes of the generated subgraph.

8. The system of claim 7, wherein the instructions are further for presenting, via a user interface, identified matching entities associated with the plurality of documents in association with citation data for those matching entities.

9. A method for comparing documents, comprising:
receiving a plurality of documents to be compared;
obtaining a graph schema defining entity types and relationships, the graph schema being subdivided into one or more subgraph schemas;
for each document:
generating a subgraph associated with each of the one or more subgraph schemas by:
providing a representation of that subgraph schema to a large language model (LLM) in association with text of the document,
receiving, from the LLM, entity data corresponding to the subgraph schema, and
generating the subgraph based on the entity data received from the LLM;
merging the plurality of subgraphs generated for the document to produce a unified graph representation of the document; and
comparing the unified graph representations of the plurality of documents to identify matching entities associated with the plurality of documents.

10. The method of claim 9, wherein the one or more subgraph schemas define overlapping entity types, and wherein the plurality of subgraphs are merged is based on the overlapping entities.

11. The method of claim 9, wherein generating the subgraph for each of the one or more subgraph schema comprises dividing each document into document portions and generating the subgraph for each document portion.

12. The method of claim 9, wherein providing the representation of that subgraph schema to the LLM comprises converting the subgraph schema into a structured representation.

13. The method of claim 12, wherein the structured representation is in a JSON format.

14. The method of claim 12, wherein generating the subgraph comprises receiving the entity data from the LLM according to the structured representation and mapping the received entity data to nodes and edges of the subgraph according to the subgraph schema.

15. The method of claim 9, wherein generating the subgraph further comprises providing citation data associated with the text to the LLM and the received entity data includes citation data, and wherein the subgraph generated based on the entity data includes citation data for entities in nodes of the generated subgraph.

16. The method of claim 15, wherein the instructions are further for presenting, via a user interface, identified matching entities associated with the plurality of documents in association with citation data for those matching entities.

17. A non-transitory computer readable medium, comprising instructions for:
receiving a plurality of documents to be compared;
obtaining a graph schema defining entity types and relationships, the graph schema being subdivided into one or more subgraph schemas;
for each document:
generating a subgraph associated with each of the one or more subgraph schemas by:
providing a representation of that subgraph schema to a large language model (LLM) in association with text of the document,
receiving, from the LLM, entity data corresponding to the subgraph schema, and
generating the subgraph based on the entity data received from the LLM;
merging the plurality of subgraphs generated for the document to produce a unified graph representation of the document; and
comparing the unified graph representations of the plurality of documents to identify matching entities associated with the plurality of documents.

18. The non-transitory computer readable medium of claim 17, wherein the one or more subgraph schemas define overlapping entity types, and wherein the plurality of subgraphs are merged is based on the overlapping entities.

19. The non-transitory computer readable medium of claim 17, wherein generating the subgraph for each of the one or more subgraph schema comprises dividing each document into document portions and generating the subgraph for each document portion.

20. The non-transitory computer readable medium of claim 17, wherein providing the representation of that subgraph schema to the LLM comprises converting the subgraph schema into a structured representation.

21. The non-transitory computer readable medium of claim 17, wherein the merging of the plurality of subgraphs comprises identifying matching entities in the plurality of subgraphs based on a graph neighborhood of those entities in the plurality of graphs or the comparison of unified graph representations to identify matching entities based on the graph neighborhood of those entities in each of the unified graph representations.

22. The non-transitory computer readable medium of claim 21, wherein identifying matching entities comprises recursively matching dependencies associated with those entities.
